(19) United States
(12) Patent Application Publication
(10) Pub. No.: US 2003/0015003 A1
(43) Pub. Date: Jan. 23, 2003

(54) Low temperature glass for insulation fiber

(76) Inventors: Diana Kim Fisler, Littleton, CO (US); Jon Frederick Bauer, Castle Rock, CO (US)

Correspondence Address: Robert D. Touslee, Johns Manville Corporation, 10100 West Ute Avenue, Littleton, CO, 80217, US

(21) Appl. No.: 09/840,435

(22) Filed: Apr. 23, 2001

Related U.S. Application Data
(60) Provisional application No. 60/279,530, filed on Mar. 28, 2001.

(51) Int. Cl. C03C 3/091

(52) U.S. Cl. 65/482; 501/66; 65/475

(57) ABSTRACT

Glass fibers, particularly those prepared by flame attenuation, display excellent chemical resistance to both acids and moisture while being highly biosoluble at the same time. The glass compositions used to make the fibers consisting essentially of: 38-52 wt % SiO₂, 8-17 wt % A1₂0₃, 7-17 wt % B₂0₃, 0-7 wt % RO, wherein R is Ca, Mg, in a combination thereof, 20-31 wt R¹₂0, wherein R¹ is Na, K, or a combination thereof, and 0-2.5 wt % Li₂0, and has a Final Aged Tensile Value of at least 3000; a HTV of 1700° F. or less and a liquidus temperature at least 200° F. lower than HTV.

### BACKGROUND OF THE INVENTION

1. Field of the Invention

The present invention pertains to fiberglass products prepared from glass compositions suitable for a process involving flame attenuation. The glass fibers exhibit good biosolubility and excellent moisture resistance.

2. Description of the Related Art

Fiberglass has a myriad of uses, including the reinforcement of polymer matrix composites; preparation of thermoformable intermediate products for use as headliners and hoodliners in vehicles; air and water filtration media; and sound and thermal insulation products. The preparation and/or subsequent processing of such materials often involves handling steps which result in cut or broken fibers which may be inhaled. As it is impractical or impossible to remove such fibers from the body, it has become important to create glass compositions which exhibit high degrees of biosolubility, i.e. which are rapidly solubilized in biological fluids.

If high biosolubility were the only factor which need be considered, a solution to the biosolubility problem would be rapidly attained. However, in addition to being biosoluble, glass fibers must also possess a number of other physical and chemical characteristics. For example, in many applications such as in battery separators, high chemical (e.g. acid) resistance is required. As can be readily imagined, high chemical resistance and high biosolubility are largely conflicting characteristics.

Glass fibers must also be strong and moisture-resistant. If moisture weakens glass fibers appreciably, their applicability to many uses suffers. Weakened glass fibers not only possess less than desired tensile strength and modulus, but also break and fracture more easily, thus increasing the risk of inhalation, etc. By the same token, moisture resistant glass fibers which have low strength to begin with also do not fulfill many requirements. For example, building insulation is shipped in compressed form. If the glass fibers of the insulation product are weak or brittle, many fibers will be broken during compression, not only increasing the number of small fibers which are bioavailable, but also producing an inferior product which may not recover a sufficient amount of its pre-compressed thickness. Strong fibers which are not moisture resistant also exhibit a great deal of breakage, especially under humid storage, as illustrated hereinafter. Finally, glass fibers must be prepared from glass compositions which can be economically processed.

The two principle methods of glass wool fiber production are the pot and marble process and the centrifugal or “rotary” process. In the latter, molten glass enters a centrifugal spinner from the forehearth of a glass melting furnace. As the centrifugal spinner rotates, relatively large diameter glass strands stream from orifices located in the spinner's periphery. These large diameter strands immediately contact an intense hot gas jet produced by burners located around the spinner. The hot gas attenuates the large diameter strands into fine, elongated fibers, which may be collected on a moving belt.

The primaries exiting the pot from the pot and marble process are flame attenuated rather than hot gas attenuated, thus exposing the glass fibers to higher temperatures than in the rotary process. These higher temperatures cause a loss of the more volatile compounds of the glass composition from the outside of the fibers, resulting in a “shell” which has a different composition than the fiber interior. As a result, the biosolubility of glass fibers prepared from pot and marble fiberglass is not the same as that derived from the rotary process. As glass fibers must necessarily dissolve from the fiber ends or the cylindrical exterior, a more highly resistant shell will dramatically impede the dissolution rate. Fibers having such a shell, which are flame attenuated, are also prepared by the rod method or direct melt method. These latter methods involve conveying raw materials, in any form, to an orifice or bushing to form primaries, which are then flame attenuated, as in the pot and marble method.

While flame attenuated fibers exhibit excellent chemical and moisture resistance due to this core/sheath structure, biosolubility of the fibers desirably should be improved. The industry would find useful a fiberglass which exhibited excellent moisture resistance as well as good biosolubility. It is greatly desirable to provide glass compositions that can be processed to produce the fiberglass at lower temperatures without the detrimental effect of glass crystallization associated with conventional fiberglass processing.

### SUMMARY OF THE INVENTION

It has now been surprisingly discovered that glass fibers of enhanced biosolubility may be prepared from glass compositions suitable for flame attenuation processing, which have well defined formulations. The fibers have a core/sheath structure where the outer shell (sheath) has a different composition than the core portion (fiber interior).

In one aspect, the present invention provides a glass fiber prepared from a glass composition consisting essentially of: 38-52 wt % SiO₂, 8-17 wt % Al₂O₃, 7-17 wt % B₂O₃, 0-7 wt % RO, wherein R is Ca, Mg, or a combination thereof, 20-31 wt % R₂O, wherein R is Na, K, or a combination thereof, and 0-2.5 wt % Li₂O. Preferably, the glass fiber according to the invention is prepared from a glass composition consisting essentially of: 40-52 wt % SiO₂, 8-15 wt % Al₂O₃, 8-15 wt % B₂O₃, 0-7 wt % RO, wherein R is Ca, Mg, or a combination thereof, 20-28 wt % R₂O, wherein R is Na, K, or a combination thereof, and 0-2.0 wt % Li₂O. Most preferably, the glass fiber according to the invention is prepared from a glass composition consisting essentially of: 41-49 wt % SiO₂, 8-12 wt % Al₂O₃, 10-15 wt % B₂O₃, 0-5 wt % RO, wherein R is Ca, Mg, or a combination thereof, 20-25 wt % R₂O, wherein R is Na, K, or a combination thereof, and 0-1.0 wt % Li₂O.

The glass compositions of the present invention have a liquidus temperature preferably at least 100° F. lower than the fiberization temperature, and more preferably at least 250° F. lower, and most preferably at least 300° F. lower than the fiberization temperature. When fibers are to be prepared using a rotary process, the liquidus temperature needs to be lower than the fiberization temperature by at least 100° F., whereas preparation by flame attenuation preferably employs a difference of at least 250° F.

The preferred glass compositions according to the invention are compositions that can be processed at a fiberization temperature of no higher than 1700° F., more preferably from 1450 to 1700° F., and most preferably, from 1500 to 1650° F., without crystallization during processing.

It is also important that the predicted Final Aged Tensile for a fiber prepared from the composition is at least 3000 for rotary processing, and preferably at least 4000 for flame attenuation. For it has been found that the predicted Final Aged Tensile is an important indication of the quality and performance of fibers prepared from the glass composition under consideration.

Preferred glass compositions include compositions having a SiO₂ content of 45 wt % or greater, compositions having a Al₂O₃ content of 12 wt % or greater, compositions having a B₂O₃ content of 12 wt % or greater, compositions having a combined Al₂O₃ and B₂O₃ content of 24 wt % or greater, and compositions having a combined Al₂O₃ and B₂O₃ content of 20 wt % or greater and a SiO₂ content of 45 wt % or less.

It has been unexpectedly found that the compositions of the invention have relatively low HTV temperatures, yet possess liquidus temperatures well below the HTV temperature. As discussed below, compositions according to the invention can have a HTV temperature under 1490° F. and a difference between the HTV and liquidus temperatures (ΔT) higher than 100° F., more preferably the difference is greater than 250° F., and most preferably greater than 300° F. Preferably, the glass compositions according to the invention are processed at a fiberization temperature of from 1450 to 1700° F. without crystallization during processing.

In another aspect, the invention provides a method for preparing glass fibers, which comprises contacting a primary with sufficient high temperature to create a loss of the more volatile compounds of the glass composition from the outside of the primaries to thereby create an outside shell which has a different composition than the fiber interior, where the primaries are prepared from a composition comprised of, 38-52 wt % SiO₂, 8-17 wt % Al₂O₃, 7-17 wt % B₂O₃, 0-7 wt % RO, wherein R is Ca, Mg, or a combination thereof, 20-31 wt % R₂O, wherein R is Na, K, or a combination thereof, and 0-2.5 wt % Li₂O, with the glass fibers exhibiting biodissolution in excess of 150 ng/cm²/hr. The compositions of the present invention can also be used to prepare glass fibers by a rotary process while still enjoying the benefits of good fiberization at low temperatures of no greater than 1700° F.

In a further aspect, the invention provides a mat containing glass fibers prepared from a glass composition consisting essentially of: 38-52 wt % SiO₂, 8-17 wt % Al₂O₃, 7-17 wt % B₂O₃, 0-7 wt % RO, wherein R is Ca, Mg, or a combination thereof, 20-31 wt % R¹₂O, wherein R¹ is Na, K, or a combination thereof, and 0-2.5 wt % Li₂O.

### DESCRIPTION OF THE PREFERRED EMBODIMENTS

The glass composition of the glass fibers of the present invention must fall within the following range of composition, in weight percent:

| | |
|---|---|
| SiO₂ | 38-52 |
| Al₂O₃ | 8.00-17.00 |
| B₂O₃ | 7.00-17.00 |
| RO | 0.00-7.00 |
| R¹₂O | 20.00-31.00 |
| LiO₂ | 0.00-2.5. |

where R¹₂O is an alkali metal oxide and RO is an alkaline earth metal oxide. R¹₂O is preferably Na₂O and/or K₂O.

At the same time, the HTV and liquidus of the overall composition must be suitable for glass fiber processing. It is preferred that the subject invention glasses have HTV and liquidus which are suitable for production of glass fibers in the pot and marble process. Such glass generally must have a HTV (10³ poise) and a liquidus temperature such that the difference between the HTV and the liquidus temperatures is of 250° F. or higher, and more preferably a difference of at least 300° F.

It has been unexpectedly found that the glass compositions according to the invention can have a HTV temperature as low as 1490° F., yet exhibit liquidus temperatures with a ΔT as high as 500° F.

By providing glass compositions having a low HTV (10³ poises) and a ΔT higher than 100° F., the present invention allows for the preparation of fiberglass at a significantly lower cost. Due to the unexpectedly low melting and working temperatures obtained with the glass compositions of the invention, fiberglass is produced at fiberization temperatures appreciably lower than those used in conventional operations, which allows for significant savings in the cost of producing the fiberglass.

Cost reduction obtained with low temperature processing is the result of (1) reduced fiberization and melting energy cost, (2) reduced refractory wear and extended service life between rebuilds, and (3) reduced corrosion and creep failure in metallic devices used in the formation of the fibers themselves. In addition, decreased employing glass compositions having low melting and working temperatures provides glass materials having a lower viscosity at common fiberization temperatures, thereby providing higher pull rates which also contributes to reducing the cost associated with fiberglass production.

This invention discloses fiberizable glass compositions that achieve the above savings while still providing fibers with sufficient strength and moisture resistance to be useful in industrial products. The compositions of the invention have physical properties that are highly suitable for fiberglass production. These compositions can be obtained by decreasing the silica content while increasing the alumina, boron, and soda content of the glass compositions.

It has been found that increasing alumina content preserves fiber durability, thus maintaining product integrity, while the increased boron and soda lower the viscosity. It has also been found that these compositions can be melted and fiberized at temperatures of at least 100° F. (56° C.) lower than any current glass used in the production of insulation fiber.

It should be noted that while the compositions of the invention may have higher batch costs due to lower silica contents, it has been unexpectedly found that the increased batch cost is offset by the reduced operation costs afforded by significant reduction in the temperature during the production of the fiberglass, which results in a significant reduction of the overall production cost.

The glass compositions of the invention allow for the production of flame attenuated glass of high biosolubility, while yet maintaining other necessary physical properties such as chemical resistance and moisture resistance.

For a glass composition to be suitable for industrial production of fiberglass, it should have sufficient moisture resistance in product yet be capable of breaking down in the aqueous environment of the lung. One such product is described in U.S. Pat. No. 5,945,360, the contents of which are hereby incorporated by reference in their entirety. The described produce is made of glass which has been shown to have a short residence time in the lung, based on the results of several animal inhalation tests and biodissolution rate (k_{dis}) evaluations. The properties of the product may be used as a reference point for acceptable biosolubility of the composition of the present invention.

It has been unexpectedly found that the composition of the invention possess similar durability and biosolubility to the aforementioned. It has been found that although the compositions of the invention are low in silica, they perform well in terms of durability due to their increased alumina content. In this regard, it has been discovered that increasing the alumina content of the glass compositions of the invention improves the durability of fiberglass made thereof without greatly affecting the biosolubility of the glass material.

The procedure used to evaluate biodissolution rate is similar to that described in Law et al. (1990). The procedure consists essentially of leaching a 0.5 gram aliquant of the candidate fibers in a synthetic physiological fluid, known as Gamble's fluid, or synthetic extracellular fluid (SEF) at a temperature of 37° C. and a rate adjusted to achieve a ratio of flow rate to fiber surface area of 0.02 cm/hr to 0.04 cm/hr for a period of up to 1,000 hours duration. Fibers are held in a thin layer between 0.2 m polycarbonate filter media backed by plastic support mesh and the entire assembly placed within a polycarbonate sample cell through which the fluid may be percolated. Fluid pH is regulated to 7.4+0.1 through the use of positive pressure of 5% CO₂/95% N₂ throughout the flow system.

Elemental analysis using inductively coupled plasma spectroscopy (ICP) of fluid samples taken at specific time intervals are used to calculate the total mass of glass dissolved. From this data, an overall rate constant could be calculated for each fiber type from the relation:

k=[dₒ (1-(M/Mₒ)^{0.5}])/2t

where k is the dissolution rate constant in SEF, dₒ the initial fiber diameter, the initial density of the glass comprising the fiber, Mₒ the initial mass of the fibers, M the final mass of the fibers (M/Mₒ=the mass fraction remaining), and t the time over which the data was taken. Details of the derivation of this relation is given in Leineweber (1982) and Potter and Mattson (1991). Values for k may be reported in ng/cm²/hr and preferably exceed a value of 150. Replicate runs on several fibers in a given sample set show that k values are consistent to within 3 percent for a given composition.

Data obtained from this evaluation can be effectively correlated within the sample set chosen—dissolution data used to derive k_{dis} were obtained only from experimental samples of uniform (3.0 μm) diameter and under identical conditions of initial sample surface area per volume of fluid per unit time, and sample permeability. Data was obtained from runs of up to 30 days to obtain an accurate representation of the long term dissolution of the fibers. Preferred biodissolution rate constants in ng/cm²/hr are greater than 150 ng/cm²/hr, preferably greater than 200 ng/cm²/hr, more preferably greater than 300 ng/cm²/hr, and most preferably greater than 400 ng/cm²/hr.

It has been shown in the following four references that there are parallel paths to lung clearance. The solubility at pH 4.5 predicts lung clearance for fibers that are insoluble at pH 7.4. The proposed mechanism is a macrophage mechanism described in the I. Carr reference below. Therefore, the low silica compositions of the present invention are expected to provide acceptable lung clearance rates, even with high levels of alumina, known to decrease solubility at neutral pH. The references are:

Knudsen, T., Guldberg, M., Christensen, V. R., Jensen, S. L., New type of stonewool (HT-fibres) with a high dissolution rate at pH4.5, Glastechn. Ber. Glass Sci. Technol. 1996; 69:331-337.

Kamstrup, O., Davis, J. M. G., Ellehauge, A., and Guldberg, M., The biopersistence and pathogenicity of man-made vitreous fibres after short- and long-term inhalation, Ann. Occup. Hyg., 42(3):191-199, 1998.

Carr, I., The Macrophage—A Review of Ultrastructure and Function, New York: Academic Press, 1973.

Oberdörster, G., Deposition, elimination and effects of fibres in the respiratory tract of humans and animals, VDI Berichte 1991; 853:17-37.

The glass fibers of the present invention thereby can offer one the benefits of a core/sheath structure fiber in terms of moisture resistance, while also enjoying good biodissolution. The glass fibers of the present invention are preferably prepared by a process involving flame attenuation, such as the rod method or pot and marble method, with application to the pot and marble method being most preferred. As mentioned previously, the primaries in a flame attenuation process are exposed to higher temperatures than hot gas attenuation. The primaries are contacted with a sufficiently high temperature to create a shell due to the loss of the more volatile compounds of the glass composition from the outside of the fibers. The resulting fiber has an outside shell which has a different composition than the fiber interior.

The primaries are typically drawn from a multitude of orifices by sets of pull rolls or other relatively slow speed drawing devices that both draw the primaries in a controlled way and also feed the primaries into the flame attenuation zone. Synchronized pairs or sets of rollers are used to draw all primaries at the same speed.

The primaries are drawn through orifices that can be arranged in either a circular array or a rectangular one. The circular array generally occurs in the bottom of a super alloy cylindrical pot, which is used to remelt previously melted glass in marble form. This variation, known as pot and marble, has the cylindrical pot, with rings of orifices in the bottom and an external combustion chamber around the sides of the pot. Marbles at ambient temperature are fed into the pot and are heated using radiant heat from the exterior combustion chamber. The marbles fuse and form a molten pool above the orifices from which the primaries are drawn.

Orifices may also be arranged in rows in the bottom of bushings, which typically are rectangular solid reservoir designs of electrically heated precious metal or super alloy construction. The bushings may be designed to remelt glass in marble or other geometric forms, much as is done in the pot and marble process described above. Alternately, the bushings may be fed with molten glass from small glass melting units which were fed with batch, which is a combination of the appropriate raw materials for the glass composition desired. The batch is fused in the melting units by the application of either electrical energy or fossil fuel fire burners. After melting and refining, the molten glass bath's temperature is cooled in a controlled way in order to supply the bushings with glass at the appropriate temperature.

While different techniques can be used to create the primaries, the important aspect of the present invention is that the primaries are flame attenuated to create a fiber having an outer shell with a composition different than the interior of the fiber. By employing the compositions of the present invention, it has been found that one can obtain such fibers which exhibit good moisture resistance, but also employ good biodissolution.

Having generally described this invention, a further understanding can be obtained by reference to certain specific examples which are provided herein for purposes of illustration only and are not intended to be limiting unless otherwise specified.

### EXAMPLES 1-32

### Comparative Examples C1 and C2

Examples 1-32 show the properties of 32 glass materials of varying composition. As can been seen in the tables, compositions according to the invention have HTV temperatures, liquidus temperatures, biosolubility and tensile strength values which allow processibility at lower cost, yet provide fiberglass having industrially desirable characteristics.

As discussed above, two important factors that define processibility are HTV (temperature of the melt at 10³ poise viscosity) and liquidus or crystallization temperature. The HTVs listed for this composition range are listed in the tables and range from 1490 to 1700° F. These low HTVs will enable cooler fiberization or faster pull rates as described above. A liquidus temperature at least 100° F. (56° C.) lower than HTV is desirable to avoid the detrimental formation of crystals in the cooler regions of the melters, forehearths, and within fiberization components. Compositions for the pot and marble process must have HTV at least 250 degrees higher than the liquids. HTV and liquidus values for a current commercial glass are approximately 1950° F., and 1700° F., respectively, see comparative example C2 below. It can be seen from the table that some compositions within the range of the invention may be unsuitable for use in the pot and marble process. However, most compositions will be suitable for the rotary process. It should be noted that for compositions which did not exhibit crystal growth in the laboratory, a regression based on the compositions that did show crystallization was used to predict the difference between HTV and liquids reported below. Also, for glass compositions within the claimed range that exhibit a difference between the HTV and liquidus temperatures of less than about 100-200° F., the well known addition of barium salts, such as BaSO₄ or BaCO₃ can suppress crystal growth and thereby relax the requirement of the difference between the HTV and liquidus temperatures for efficient fiberization. However, as shown in the tables below, glass compositions within the presently claimed ranges which inherently possess a difference between the HTV and liquidus temperatures of about 100-200° F. or greater are readily achieved. Thus, for most of the glass compositions within the presently claimed ranges, it is expected that no crystallization will occur during fiberization, thereby avoiding the need for adding a barium salt to the glass composition for efficient fiberization.

k_{dis} after flame attenuation has been determined for four compositions and is listed in parentheses in the tables. It can be seen from the tables that several glasses in the composition range of the invention will have sufficient biodissolution rates for the rotary process, and that several are predicted to be acceptable for flame-attenuation.

TABLE 1

| | Example 1 | Example 2 | Example 3 | Example 4 | Example 5 | Example 6 | Example 7 | Example 8 | Example 9 | Example 10 |
|---|---|---|---|---|---|---|---|---|---|---|
| | Wt % | Wt % | Wt % | Wt % | Wt % | Wt % | Wt % | Wt % | Wt % | Wt % |
| SiO₂ | 41.10 | 42.40 | 38.40 | 39.20 | 38.10 | 39.10 | 49.20 | 42.20 | 42.30 | 41.50 |
| B₂O₃ | 10.20 | 10.40 | 14.80 | 8.08 | 7.82 | 9.42 | 15.20 | 7.79 | 14.80 | 15.70 |
| Al₂O₃ | 16.40 | 16.90 | 15.60 | 15.40 | 15.10 | 15.10 | 8.31 | 15.50 | 16.10 | 15.40 |
| Li₂O | 1.06 | 1.01 | 2.03 | 2.02 | 1.96 | 0.00 | 0.00 | 2.02 | 1.94 | 1.99 |
| RO | 3.74 | 5.08 | 6.68 | 2.73 | 6.77 | 3.69 | 5.00 | 4.99 | 0.24 | 4.87 |
| R¹₂O | 27.28 | 24.09 | 22.07 | 32.16 | 29.76 | 32.31 | 22.21 | 27.35 | 24.58 | 20.48 |
| HTV | 1613 | 1687 | 1528 | 1495 | 1514 | 1565 | 1667 | 1589 | 1510 | 1590 |
| HTV-* | −68 | −23 | −22 | −200 | −206 | −83 | >300 | −115 | 35 | 168 |
| liquids ° F. | | | | | | | | | | |
| k_{dis 7.4} | 82 | 26 | 229 | 225 | | 248 | 573 | 70 | 262 | 120 |
| k_{dis 4.5} | | | | | | | 828 | | | 407 |

| | Example 11 | Example 12 | Example 13 | Example 14 | Example 15 | Example 16 | Example 17 | Example 18 |
|---|---|---|---|---|---|---|---|---|
| | Wt % | Wt % | Wt % | Wt % | Wt % | Wt % | Wt % | Wt % |
| SiO₂ | 41.70 | 42.70 | 46.40 | 42.90 | 48.00 | 41.50 | 42.50 | 42.30 |
| B₂O₃ | 15.40 | 14.40 | 7.35 | 14.20 | 15.80 | 12.30 | 9.08 | 7.65 |
| Al₂O₃ | 15.70 | 16.10 | 12.30 | 16.20 | 8.51 | 15.70 | 16.10 | 15.90 |
| Li₂O | 0.00 | 0.00 | 0.00 | 1.96 | 0.00 | 0.00 | 1.96 | 0.00 |
| RO | 4.93 | 0.26 | 5.13 | 2.52 | 0.16 | 0.28 | 0.26 | 5.01 |
| R¹₂O | 22.30 | 26.47 | 28.74 | 22.14 | 27.52 | 30.17 | 29.95 | 29.04 |
| HTV | 1702 | 1647 | 1676 | 1604 | 1570 | 1581 | 1548 | 1706 |
| HTV-* | 258 | 170 | 120 | 123 | >300 | 33 | −79 | −37 |
| liquids ° F. | | | | | | | | |
| k_{dis 7.4} | 110 | 104 | 158 | 52 | 606 | 180 | 106 | 64 |
| k_{dis 4.5} | 394 | 474 | 524 | | | | | |
| | Example 19 | Example 20 | Example 21 | Example 22 | Example 23 | Example 24 | Example 25 | Example 26 |
| | Wt % | Wt % | Wt % | Wt % | Wt % | Wt % | Wt % | Wt % |
| SiO₂ | 48.70 | 48.50 | 50.40 | 46.50 | 42.40 | 46.00 | 42.10 | 48.60 |
| B₂O₃ | 8.29 | 12.10 | 11.30 | 14.40 | 11.90 | 11.20 | 11.30 | 15.20 |
| Al₂O₃ | 8.30 | 8.29 | 8.67 | 12.30 | 15.50 | 12.40 | 15.90 | 8.66 |
| Li₂O | 0.99 | 0.00 | 2.05 | 1.01 | 0.00 | 1.08 | 1.00 | 2.02 |
| RO | 5.05 | 4.93 | 0.17 | 5.06 | 0.26 | 2.85 | 4.97 | 5.09 |
| R¹₂O | 28.59 | 26.07 | 27.34 | 20.70 | 29.90 | 26.50 | 24.64 | 20.33 |
| HTV | 1582 | 1582 | 1530 | 1670 | 1589 | 1582 | 1636 | 1577 |
| HTV-* | 105 | 262 | >300 | 417 | 59 | 108 | 219 | >300 |
| liquids ° F. | | | | | | | | |
| k_{dis 7.4} | 440 | 494(393) | 382(543) | 130(91) | 144 | 179 | 58 | 484 |
| k_{dis 4.5} | | | 559 | | | | | 694 |

| | Example 27 | Example 28 | Example 29 | Example 30 | Example 31 | Example 32 |
|---|---|---|---|---|---|---|
| | Wt % | Wt % | Wt % | Wt % | Wt % | Wt % |
| SiO₂ | 49.50 | 48.20 | 49.30 | 42.50 | 42.20 | 49.7 |
| B₂O₃ | 8.45 | 8.37 | 9.92 | 7.99 | 15.30 | 12.2 |
| Al₂O₃ | 8.61 | 8.36 | 8.55 | 15.40 | 15.40 | 9.01 |
| Li₂O | 2.02 | 2.07 | 0.00 | 2.01 | 1.95 | 0.95 |
| RO | 1.04 | 5.12 | 2.05 | 5.07 | 4.98 | 3.09 |
| R¹₂O | 30.36 | 27.75 | 30.08 | 26.96 | 20.09 | 24.88 |
| HTV | 1487 | 1491 | 1566 | 1584 | 1609 | 1586 |
| HTV-* | 267 | 50 | 312 | −103 | 137 | >300 |
| liquids ° F. | | | | | | |
| k_{dis 7.4} | 512 | 581 | 125 | 118 | 350(150) | |
| k_{dis 4.5} | | | | | | |

*a negative value is representative of predicted poor fiberization.

For comparison purposes, the glass compositions and properties of two commercial products are provided in Table 2, below.

TABLE 2

| | Example C1 | Example C2 |
|---|---|---|
| SiO_{2 wt %} | 67.00 | 56.00 |
| Al₂O₃ wt % | 1.70 | 5.00 |
| B₂O₃ wt % | 7.00 | 9.00 |
| RO wt % | 7.66 | 12.00 |
| R¹₂O wt % | 16.28 | 18.00 |
| Li₂O wt % | 0.00 | 0.00 |
| HTV ° F. | 1950 | 1790 |
| HTV - Liquidus ° F. | 250 | 100 |
| k_{dis. 7.4} | 350 | 550 |

Based on the lower HTV (viscosity) of the glass compositions of the invention compared to those associated with the compositions of comparative examples C1 and C2, the fiberization of the glass compositions of the invention can be efficiently conducted at lower temperatures and/or higher production rates. This in turn, lowers the energy cost associated with the fiberization of the glass compositions of the present invention and also reduces the rate of wearing of the fiberization equipment. Thus, the glass compositions according to the invention allow for the production of fiber glass at a cost that is significantly lower than the cost associated with the fiberization of the glass compositions of the comparative examples.

### Aged Tensile Strength of Glass Fiber

Fiberglass product performance after aging in humid environments has been correlated with laboratory tests of the tensile strength of continuous filament fiber after humid aging. The laboratory tests measure the tensile strength of glass fibers after aging for 360 hours in a warm, humid environment. A regression of the final strength of aged fiber (in kg/cm²) with the weight percent oxide components follows.

Final aged tensile=b0+b1*B₂O₃+b2*AL₂O₃+b3*Li₂O+b4*R₂O+b5*CaO+b6*MgO

where:

| | |
|---|---|
| b0 | 13203.1 |
| b1 | −157.38 |
| b2 | 448.01 |
| b3 | −1790.7 |
| b4 | 1805.2 |
| b5 | −403.47 |
| b6 | 84.08 |

A formulation must have a tensile strength of at least 3000 to perform in insulation products comparable to current wool formulations. The table lists some compositions in the range that pass this criterion, and some that fail, with the predicted Final Aged Tensile (FAT) by the regression. The regression generally shows that either alumina or silica is required to give the appropriate performance, hence low alumina, low silica compositions such as 19 fail, as do compositions with too much soda such as 4 and 6.

Preferably, the range employed is bounded by the tensile performance and is within the following:

| | |
|---|---|
| SiO₂ | 38.4-50.4 |
| B₂O₃ | 7.4-15.8 |
| Al₂O₃ | 8.3-16.9 |
| CaO | 0-4.64 |
| MgO | 0-2.1 |
| R₂O | 20.1-30.4 |
| Li₂O | 0-2.1 |

The preferred range for flame-attenuated products is defined by better humid aging durability, because of the product requirements. Therefore, the preferred range for the flame-attenuated process is bounded by tensile performance of at least 4000 by the above regression and is preferably within the following:

| | |
|---|---|
| SiO₂ | 38.4-50.4 |
| B₂O₃ | 7.4-15.7 |
| A1₂O₃ | 8.7-16.9 |
| CaO | 0-4.64 |
| MgO | 0-2.1 |
| R₂O | 20.1-30.2 |
| Li₂O | 0-2.1 |

TABLE 3

| Sample | SiO₂ | B₂O₃ | Al₋₂O₃ | CaO | MgO | RO | Na₂O | K₂O | R₂O | Li₂O | FAT |
|---|---|---|---|---|---|---|---|---|---|---|---|
| 1 | 41.1 | 10.2 | 16.4 | 2.56 | 1.18 | 3.74 | 25.3 | 1.98 | 27.28 | 1.06 | 5574 |
| 2 | 42.4 | 10.4 | 16.9 | 2.99 | 2.09 | 5.08 | 21.72 | 2.37 | 24.09 | 1.01 | 7922 |
| 3 | 38.4 | 14.8 | 15.6 | 4.64 | 2.04 | 6.68 | 19.9 | 2.17 | 22.07 | 2.03 | 4503 |
| 4 | 39.2 | 8.08 | 15.4 | 2.31 | 0.42 | 2.73 | 30 | 2.16 | 32.16 | 2.02 | 2647 |
| 5 | 38.1 | 7.82 | 15.1 | 4.72 | 2.05 | 6.77 | 27.4 | 2.36 | 29.76 | 1.96 | 2144 |
| 6 | 39.1 | 9.42 | 15.1 | 2.86 | 0.83 | 3.69 | 30.1 | 2.21 | 32.31 | 0 | 18.26 |
| 7 | 49.2 | 15.2 | 8.31 | 2.98 | 2.02 | 5 | 20.5 | 1.71 | 22.21 | 0 | 3883 |
| 8 | 42.2 | 7.79 | 15.5 | 2.99 | 2 | 4.99 | 24.1 | 3.25 | 27.35 | 2.02 | 6313 |
| 10 | 41.5 | 15.7 | 15.4 | 2.9 | 1.97 | 4.87 | 17.1 | 3.38 | 20.48 | 1.99 | 7899 |
| 11 | 41.7 | 15.4 | 15.7 | 2.91 | 2.02 | 4.93 | 19.1 | 3.2 | 22.3 | 0 | 7251 |
| 12 | 42.7 | 14.4 | 16.1 | 0.26 | 0 | 0.26 | 23.7 | 2.77 | 26.47 | 0 | 7004 |
| 13 | 46.4 | 7.35 | 12.3 | 3.08 | 2.05 | 5.13 | 26.6 | 2.14 | 28.74 | 0 | 4147 |
| 14 | 42.9 | 14.2 | 16.2 | 1.49 | 1.03 | 2.52 | 19.4 | 2.74 | 22.14 | 1.94 | 8648 |
| 15 | 48 | 15.8 | 8.51 | 0.15 | 0.01 | 0.16 | 25.8 | 1.72 | 27.52 | 0 | 3175 |
| 16 | 41.5 | 12.3 | 15.7 | 0.26 | 0.02 | 0.28 | 27 | 3.17 | 30.17 | 0 | 5699 |
| 17 | 42.5 | 9.08 | 16.1 | 0.26 | 0 | 0.26 | 27.2 | 2.75 | 29.95 | 1.96 | 6602 |
| 18 | 42.3 | 7.65 | 15.9 | 2.99 | 2.02 | 5.01 | 26.1 | 2.94 | 29.04 | 0 | 5698 |
| 19 | 48.7 | 8.29 | 8.3 | 3.04 | 2.01 | 5.05 | 26.8 | 1.79 | 28.59 | 0.99 | 2350 |
| 20 | 48.5 | 12.1 | 8.29 | 2.93 | 2 | 4.93 | 24.3 | 1.77 | 26.07 | 0 | 2858 |
| 21 | 50.4 | 11.3 | 8.67 | 0.17 | 0 | 0.17 | 25.9 | 1.44 | 27.34 | 2.05 | 4146 |
| 22 | 46.5 | 14.4 | 12.3 | 2.98 | 2.08 | 5.06 | 18.5 | 2.2 | 20.7 | 1.01 | 6599 |
| 23 | 42.4 | 11.9 | 15.5 | 0.26 | 0 | 0.26 | 26.8 | 3.1 | 29.9 | 0 | 5745 |
| 24 | 46 | 11.2 | 12.4 | 1.69 | 1.16 | 2.85 | 24.3 | 2.2 | 26.5 | 1.08 | 5462 |
| 25 | 42.1 | 11.3 | 15.9 | 2.95 | 2.02 | 4.97 | 21.6 | 3.04 | 24.64 | 1 | 7055 |
| 26 | 48.6 | 15.2 | 8.66 | 3.02 | 2.07 | 5.09 | 18.7 | 1.63 | 20.33 | 2.02 | 4987 |
| 27 | 49.5 | 8.45 | 8.61 | 0.63 | 0.41 | 1.04 | 28.8 | 1.56 | 30.36 | 2.02 | 3263 |
| 28 | 48.2 | 8.37 | 8.36 | 3.07 | 2.05 | 5.12 | 26 | 1.75 | 27.75 | 2.07 | 2812 |
| 29 | 49.3 | 9.92 | 8.55 | 1.22 | 0.83 | 2.05 | 28.5 | 1.58 | 30.08 | 0 | 2650 |
| 30 | 42.5 | 7.99 | 15.4 | 3.07 | 2 | 5.07 | 23.6 | 3.36 | 26.96 | 2.01 | 6250 |
| 31 | 42.2 | 15.3 | 15.4 | 3 | 1.98 | 4.98 | 16.7 | 3.39 | 20.09 | 1.95 | 7955 |
| 32 | 49.7 | 12.2 | 9.01 | 1.79 | 1.3 | 3.09 | 23 | 1.88 | 24.88 | 0.95 | 4503 |

In the foregoing Table 3, the Samples in bold (i.e., Samples 4, 5, 6, 19, 20, 28 and 29) demonstrate a FAT value below 3000. Thus, even though the composition may be comprised of components within the desired ranges, the product quality will be unacceptable. When the product is stored in warm, humid conditions, it will fail to recover advertised thickness. The fibers will also soften, and the entire product will fall apart. The samples of the present invention, with a FAT value greater than 3000 (suitable for rotary processing) and preferably greater than 4000 (suitable for flame attenuation or rotary processing) provide an excellent fiber product at an economic cost.

By the term “consisting essentially of” is meant that additional ingredients may be added provided they do not substantially alter the nature of the composition. Substances which cause the biodissolution rate to drop below 150 ng/cm²/hr or which lower the ΔT to a value below 350° F. are substances which do substantially alter the composition. Preferably, the glass compositions are free of iron oxides, lead oxides, fluorine, phosphates (P₂O₅), zirconia, and other expensive oxides, except as unavoidable impurities.

Having now fully described the invention, it will be apparent to one of ordinary skill in the art that many changes and modifications can be made thereto without departing from the spirit or scope of the invention as set forth herein.

What is claimed is:

1. A glass fiber exhibiting good moisture resistance wherein said fiber is prepared from a glass composition consisting essentially of:
38-52 wt % Si0₂,
8-17 wt % A1₂0₃,
7-17 wt % B₂0₃,
0-7 wt % R0, wherein R is Ca, Mg, or a combination thereof,
20-31 wt % R¹₂0, wherein R¹ is Na, K, or a combination thereof, and
0-2.5 wt % Li₂0
and has a Final Aged Tensile value of at least 3000;
a HTV of 1700° F. or less and a liquidus temperature at least 100° F. lower than the HTV.

2. The glass fiber of claim 1, wherein the Final Aged Tensile value is at least 4000.

3. The glass fiber of claim 2, wherein the glass composition has a liquidus temperature at least 300° F. lower than the fiberization temperature.

4. The glass fiber of claim 2, wherein the glass composition has a liquidus temperature at least 400° F. lower than the fiberization temperature.

5. The glass fiber of claim 2, wherein the glass composition has a liquidus temperature at least 450° F. lower than the fiberization temperature.

6. The glass fiber of claim 1, wherein said glass composition is processed at a fiberization temperature of from 1450 to 1700° F. without cyrstallization during processing.

7. The glass fiber of claim 1, wherein said glass composition is processed at a fiberization temperature of from 1500 to 1650° F. without crystallization during processing.

8. The glass fiber of claim 1, wherein said glass composition is processed at a fiberization temperature of from 1450 to 1700° F. without crystallization during processing and has a liquidus temperature at least 100° F. lower than the fiberization temperature.

9. The glass fiber of claim 1, wherein said glass composition is processed at a fiberization temperature of from 1450 to 1700° F. without crystallization during processing and has a liquidus temperature at least 300° F. lower than the fiberization temperature.

10. The glass fiber of claim 1, wherein said glass composition is processed at a fiberization temperature of from 1450 to 1700° F. without crystallization during processing and has a liquidus temperature at least 400° F. lower than the fiberization temperature.

11. The glass fiber of claim 1, wherein said glass composition has a Si0₂ content of 45 wt % or greater.

12. The glass fiber of claim 1, wherein said glass composition has a A1₂0₃ content of 12 wt % or greater.

13. The glass fiber of claim 1, wherein said glass composition has a B₂0₃ content of 12 wt % or greater.

14. The glass fiber of claim 1, wherein said glass composition has a combined A1₂0₃ and B₂0₃ content of 24 wt % or greater.

15. The glass fiber of claim 1, wherein said glass composition has a combined A1₂0₃ and B₂0₃ content of 20 wt % or greater and a Si0₂ content of 45 wt % or less.

16. The glass fibers of claim 1, wherein said fibers have a measured biodissolution rate of greater than 300 ng/cm²/hr.

17. The glass fibers of claim 2, wherein said fibers have a measured biodissolution rate of greater than 300 ng/cm²/hr.

18. The glass fibers of claim 3, wherein said fibers have a measured biodissolution rate of greater than 300 ng/cm²/hr.

19. The glass fibers of claim 1, wherein said fibers have a measured biodissolution rate of greater than 400 ng/cm²/hr.

20. The glass fibers of claim 2, wherein said fibers have a measured biodissolution rate of greater than 400 ng/cm²/hr.

21. The glass fibers of claim 3, wherein said fibers have a measured biodissolution rate of greater than 400 ng/cm²/hr.

22. A glass fiber exhibiting chemical resistance, moisture resistance, and biosolubility, wherein said fiber is prepared from a glass composition consisting essentially of:
40-52 wt % Si0₂,
8-15 wt % A1₂0₃,
8-15 wt % B₂0₃,
0-7 wt % R0, wherein R is Ca, Mg, or a combination thereof,
20-28 wt % R¹₂0, wherein R¹ is Na, K, or a combination thereof, and
0-2.0 wt % Li₂0
and has a Final Aged Tensile value of at least 3000;
a HTV of 1700° F. or less and a liquidus temperature at least 100° F. lower than HTV.

23. A glass fiber exhibiting chemical resistance, moisture resistance, and biosolubility, wherein said fiber is prepared from a glass composition consisting essentially of:
41-49 wt % Si0₂,
8-12 wt % A1₂0₃,
10-15 wt % B₂0₃,
0-5 wt % R0, wherein R is Ca, Mg, or a combination thereof,
20-25 wt % R¹₂0, wherein R¹ is Na, K, or a combination thereof, and
0-1,0 wt % Li₂0
and has a Final Aged Tensile value of at least 3000;
a HTV of 1700° F. or less and a liquidus temperature at least 100° F. lower than HTV.

24. A method for preparing glass fibers, which comprises contacting a primary with sufficient high temperature to create a loss of more volatile compounds of the glass composition from the outside of the primary to thereby create an outside shell which has a different composition than the fiber interior, wherein the primaries are prepared from a composition comprised of:
40-52 wt % Si0₂,
7-17 wt % A1₂0₃,
7-17 wt % B₂0₃,
0-7 wt % R0, wherein R is Ca, Mg, or a combination thereof,
20-31 wt % R¹₂0, wherein R¹ is Na, K, or a combination thereof, and
0-2.5 wt % Li₂0
wherein the glass fibers exhibit biodissolution in excess of 150 ng/cm²/hr,
and has a Final Aged Tensile value of at least 3000;
a HTV of 1700° F. or less and a liquidus temperature at least 100° F. lower than the HTV.

25. The method of claim 24, wherein the composition is processed at a fiberization temperature of from 1450 to 1700° F. without crystallization during processing.

26. The method of claim 24, wherein a pot and marble technique is employed to prepare the glass fibers.

27. The method of claim 24, wherein a direct melt method is employed to prepare the glass fibers.
